(19) United States
(12) Patent Application Publication
(10) Pub. No.: US 2003/0033611 A1
(43) Pub. Date: Feb. 13, 2003

(54) Embedded information modulation and demodulation using spectrum control orthogonal filter banks

(76) Inventors: Jerome M. Shapiro, Belmont, MA (US); Brian Chen, Boston, MA (US); Richard J. Barron, Cambridge, MA (US)

Correspondence Address: Randy J. Pritzker, Wolf, Greenfield & Sacks, P.C., Federal Reserve Plaza, 600 Atlantic Avenue, Boston, MA, 02210, US

(21) Appl. No.: 09/925,615

(22) Filed: Aug. 9, 2001

(51) Int. Cl. H04N 7/173; H04N 7/16; H04N 7/00; H04N 11/00

(52) U.S. Cl. 725/136; 348/460; 348/461; 348/468; 725/111

(57) ABSTRACT

A method and apparatus for information embedding modulation and information extraction demodulation are presented which use analysis and/or synthesis filter banks. Spectral control of the form of the composite signals arising from the embedding of digital embedded information signals into digital host signals is provided. Various implementations, including cable head-end and user-end systems using such modulators are presented. One aspect of the modulator allows for reduced noise spillover into adjacent communication channels in a multi-channel communication system. In some implementations the analysis and the synthesis filter banks form perfect reconstruction filter sets. In other implementations, block transforms are used as the filter banks.

### FIELD OF THE INVENTION

This invention relates to the field of communication. Specifically, the invention addresses the combination of a host communication signal and an embedded signal to yield a composite signal by a modulator, and the extraction of embedded signals from composite signals by a demodulator.

### BACKGROUND

A variety of applications exist for providing data to a user through communication channels used for transmitting host signals, such as television signals. For example, closed captioning and teletext systems are employed to display textual data that are associated with a television program. Additional applications include sending telephony, Internet, video enhancement, video-on-demand, video-streaming, or audio-streaming data over television communications channels. Host communication channels include those associated with broadcast “over-the-air” from ground-based antennas, from satellites, and over cable networks.

Cable networks typically are referred to as having a “head end” from which the cable television signals are transmitted. The communication channels through which the transmissions occur may include fiber optic cables and coaxial cables, as well as a variety of switches, relays, and other conventional network components. Public switched telephone networks (PSTNs) or other telephone networks may also constitute, or be included in, the cable network. For the sake of convenience, these communication channels are referred to herein simply as “cables.” The television signals are received at what are referred to herein as “user ends.” For example, a cable network customer receives television (TV) signals at a user end, where the signals may be coupled to television receivers, video recorders, computers, and other devices.

A variety of sources of television signals may be coupled to the head end for transmission of the television signals over a cable network. These television signals may include, for example, various commercial or public broadcast signals. Television signals include both video signals and audio signals, and may also include data signals. The television signals typically are multiplexed at the head end into what is referred to herein as “head-end multiplexed signals,” meaning a group of television signals assembled at various carrier frequencies across a band of frequencies. The organizational scheme according to which these signals are assembled at the head end is commonly referred to as a “cable plant.”

In addition to carrying digital television signals, a portion of the cable plant may be dedicated to carrying conventional data signals from the head end to the user ends. In particular, an industry standard referred to as the Data Over Cable Service Interface Specification (DOCSIS) provides that cable operators may select portions of the cable plant within this range for the transmission of data signals. These data signals may include captioning, teletext, telephony, Internet, television-enhancement, video-on-demand, video-streaming, audio-streaming, or other types of data.

Several approaches are available for addressing the problem of limited bandwidth or data capacity in a conventional multi-drop cable configuration. One approach is to reduce the number of homes in a cable neighborhood (or “node”). Alternatively, additional cable nodes may be created, each associated with its own common cable. A disadvantage of this approach, however, is the significant additional expense to the cable company of providing the additional cable from the head end to the users.

Other approaches to increasing data capacity are applicable not only to cable systems, but also to other forms of television broadcasting such as over-the-air or satellite broadcasting. A reason to apply these approaches in non-cable systems is to increase opportunities to provide a variety of data services.

One of these approaches is to replace one or more television signals with data signals. For example, a cable operator could replace the television signals transmitted over one or more of analog television channels and/or over digital television channels with data only. A disadvantage of this approach is that the elimination of television signals typically reduces revenues and also reduces the attractiveness of the cable service to users because of the reduced choice of television signals.

Another approach to increasing the capacity of cable networks, or of other television broadcasting systems, is to transmit the data with one or more analog television signals according to certain approved conventional methods. In the United States, the Federal Communications Commission (FCC) has approved the inclusion of data signals with analog television signals according to certain methods in over-the-air television broadcast transmissions. See “Digital Data Transmission Within the Video Portion of Television Broadcast Station Transmissions,” FCC Report and Order, MM docket No. 95-42 (approved Jun. 21, 1996; published Jun. 28, 1996). Even prior to that order, the FCC had permitted the transmission of “ancillary telecommunications services” within the Vertical Blanking Interval (VBI) of television broadcast signals in the NTSC (National Television System Committee) standard used in the United States and elsewhere. The VBI is a portion of the NTSC broadcast television signal that has no viewable content, i.e., it contains no video signal. The reason for creating this blank portion is to allow time for the electron gun of the television receiver's cathode ray tube to move from the bottom to the top of the screen after scanning an image across the screen.

The VBI has been used to transmit such data as closed captioning and HTML-formatted information. For example, using the Intercast protocol developed by Intel Corporation in 1996, CNN broadcasts links to its Internet pages to provide additional information related to its television programs.

The FCC order of June 1996 referred to above, permits broadcasters to transmit ancillary information using so-called “overscan” methods proposed, as well as “subvideo” methods. In the overscan method, data replaces a portion of the video signal that is not normally seen by television viewers. For example, a method proposed by Yes! Entertainment uses the extreme left edge of the picture, and other methods use the first line of active video (after the VBI) at the top of the picture. In many television receivers, these edges are blocked from viewing by the television cabinet. Overscan systems are capable of transmitting data at relatively low rates, on the order of 15 to 20 kilobits per second.

The sub-video technique takes advantage of portions of the 6-MHz bandwidth of a television signal that are typically filtered out by a television receiver. In other words, these are “blank” frequencies. Because the blank frequencies typically are not used to transmit either the video or audio portion of the television signal, data may be inserted into them without interfering with either the picture or sound presented to the viewer. These techniques allow data rates on the order of 300 to 500 kilobits per second. The restricted data rates are due to the fact that the blank frequencies constitute a small portion of the full 6-MHz bandwidth.

### SUMMARY

Generally, various embodiments of the present invention are directed to information embedding modulators and information extraction demodulators. Communication systems and methods for modulating and demodulating using orthogonal filter banks are also provided. Many equivalents to the given embodiments exist and can be developed using the novel concepts presented herein.

In one embodiment, an information embedding modulator system for generating a composite signal from an embedded information signal and a host signal, comprises: an analysis filter bank operating on the host signal, the analysis filter bank producing a plurality of analysis filter branch output signals; an information embedder for embedding the embedded information signal into a selected analysis filter branch output signal; a synthesis filter bank producing a plurality of synthesis filter branch output signals; and a combiner for combining the synthesis filter branch output signals; wherein the combiner yields a composite signal comprising information from both the host signal and the embedded information signal.

In another embodiment, a method for modulating a host signal with an embedded information signal, comprises: (a) passing the host signal through an analysis filter bank having a plurality of analysis filter branches; (b) embedding the embedded information signal into a selected filter branch output signal of the analysis filter bank to produce a composite branch signal; (c) passing the composite branch signal and outputs from other analysis filter bank output branch signals through a synthesis filter bank having a plurality of synthesis filter branches; and (d) combining outputs of the synthesis filter bank branches using a combiner to produce a composite signal.

In yet another embodiment, a method for modulating a host signal with an embedded information signal, comprises: (a) splitting the host signal into a plurality of filtered branch signals using an analysis filter bank; (b) decimating the filtered signals from (a) using down-samplers placed in at least one of the filtered branches; (c) embedding an embedded information signal into at least one of the decimated filtered signals from (b) using an information embedder, producing at least one decimated branch composite signal; (d) interpolating each of the signals from (b) and the decimated branch composite signals from (c) using up-samplers placed in each of the branches containing the signals from (b) and (c); (e) filtering each of the interpolated signals from (d) using a synthesis filter bank corresponding to that signal; and (f) combining outputs of each branch in (e) to produce a composite signal comprising elements of both the host signal and the embedded information signal.

In another embodiment, a method for embedding an embedded information signal into a host signal occupying a host signal channel, with reduced spillover of the embedded information signal into signal channels adjacent to the host signal channel, comprising: splitting the host communication channel into a plurality of components using an analysis filter bank, the analysis filter bank having a plurality of output branches; decimating the host signal component in at least one of the output branches to produce a decimated host signal; and embedding the information signal into the decimated host signal to produce a decimated composite signal containing the information signal and the decimated host signal.

Another exemplary embodiment provides a cable head-end system adapted for embedding an embedded information signal into a host signal, comprising: a broadcast signal receiver receiving at least one broadcast channel; an information embedding modulator for generating a composite signal from the at least one broadcast channel and an embedded information signal, the modulator comprising: an analysis filter bank operating on the host signal, the analysis filter bank having at least an analysis high-pass filter branch and an analysis low-pass filter branch; an information embedder for embedding the embedded information signal into a selected analysis filter branch output; a synthesis filter bank, having at least a synthesis high-pass filter branch and a synthesis low-pass filter branch; and an adder for adding outputs of the synthesis filter branches, the adder yielding a composite signal containing information from both the host signal and the embedded information signal; and a transmitter for transmitting the composite signal to a user.

In another embodiment, an information embedding modulator system for embedding an embedded information signal into a host signal is provided, comprising: an analysis filter bank operating on the host signal, the analysis filter bank having an analysis filter branch with a corresponding analysis filter branch output; an information embedder for embedding the embedded information signal into the analysis filter branch output; a first combiner for subtracting the analysis filter branch output from an output of the information embedder; a synthesis filter bank, having an input from the output of the first combiner; and a second combiner for combining an output of the synthesis filter bank and the host signal, the second combiner yielding a composite signal containing information from both the host signal and the embedded information signal.

One illustrative embodiment is directed to a method for embedding an embedded information signal into a host signal occupying a host signal channel, with reduced spillover of the embedded information signal into signal channels adjacent to the host signal channel, comprising: splitting the host communication channel into a plurality of components using an analysis filter bank, said analysis filter bank having an analysis filter branch component; decimating the host signal component in the analysis filter branch component to produce a decimated filtered host signal; and embedding the information signal into the decimated filtered host signal to produce a decimated filtered composite signal comprising the embedded information signal and the decimated filtered host signal.

Another embodiment is directed to an information extracting demodulator system for extracting embedded information from a composite signal, comprising: an analysis filter bank, operating on the composite signal, the analysis filter bank having an analysis filter output; and an information extractor for extracting embedded information from the analysis filter output.

Yet another embodiment describes a method for demodulating a composite signal, comprising: (a) filtering the composite signal using an analysis filter bank; (b) extracting embedded information from the composite signal to yield extracted information corresponding to the embedded information.

One embodiment further provides a communication system, for delivering information from a head end to a user end, comprising: an information embedding modulator for embedding embedded information into a host signal, the modulator comprising a modulator analysis filter bank, an information embedder, a synthesis filter bank, and a combiner for providing a composite signal containing information from both the host signal and the embedded information signal, and an information extracting demodulator, the demodulator comprising a demodulator analysis filter bank receiving and filtering the composite signal, and an information extractor for extracting the embedded information.

In another illustrative embodiment, a method for communicating between a cable head end and a user end with reduced spillover of an embedded information signal into signal channels adjacent to a host signal channel is given, comprising: embedding the embedded information signal into at least a portion of the host signal using an information embedder, wherein the portion of the host signal has a bandwidth smaller than the bandwidth of the host signal channel; modulating the host signal with the embedded information signal using an information embedding modulator, producing a composite signal comprising information from both the host signal and the embedded information signal; transmitting the composite signal over a communication channel to the user end; receiving the composite signal at the user end; and demodulating the composite signal using an information extraction demodulator adapted for extracting the embedded information signal from the composite signal.

Many advantages can be achieved by practicing the present invention, as covered by the scope of the accompanying claims. Some advantages of some embodiments include, not by way of limitation: increasing the communication rate between a head-end and a user-end of a communication system; utilizing unused bandwidth in cable communication systems; delivering associated data and information to a user of a communication channel; and increasing the amount of information delivered per unit time without undue noise spillover between adjacent communication channels. These aspects are only a partial list, not an exhaustive list, and may be provided by some or all embodiments, some of which are described herein for illustrative purposes.

### BRIEF DESCRIPTION OF THE DRAWINGS

Aspects of the present invention will be more clearly appreciated from the following Detailed Description section when taken in conjunction with the accompanying drawings, in which like reference numerals indicate like structures or method steps.

FIG. 1 is a high-level schematic diagram of an embodiment of an information embedding modulator.

FIG. 2 is a high-level schematic diagram of an embodiment of an information extracting demodulator.

FIG. 3 is a schematic diagram of another embodiment of an information embedding modulator, showing low and high pass filter branches.

FIG. 4 is a schematic diagram of yet another embodiment of an information embedding modulator, using samplers.

FIG. 5 is a schematic diagram of an embodiment of an information embedding modulator having multiple filter branches.

FIG. 6 is a schematic diagram of an embodiment of an information embedding modulator using a block transform implementation and having several branches.

FIG. 7 is a schematic diagram of an embodiment of an information extracting demodulator using a block transform implementation.

FIG. 8 is a schematic diagram of an embodiment of a cable head end system comprising an information embedding modulator.

FIG. 9 is a schematic diagram of an embodiment of a cable head end system with a multiplexer.

FIG. 10 is a schematic diagram of an embodiment of a user end system, comprising an information extracting demodulator.

FIG. 11 is a schematic diagram of an embodiment of an information embedding modulator using an inverter.

FIG. 12 is a schematic diagram of an embodiment of an information embedding modulator using inverters, multiple branches and block transforms.

FIG. 13 is an illustrative flow diagram showing a method for information embedding in an information embedding modulator.

FIG. 14 is an illustrative flow diagram showing a method for information extraction in an information extracting demodulator.

FIG. 15 is a diagram showing a signal level of an embedded information signal relative to a noise floor and showing a guard band.

FIG. 16 shows the relative bandwidth of an embedded information signal, a television channel, and the guard bands.

### DETAILED DESCRIPTION

In some aspects the present invention is described in the context of cable networks and television signal transmissions. However, the invention is not so limited, and may be implemented in connection with any other type of system used for broadcasting or otherwise delivering or receiving communication signals, including over-the-air and on television, radio, satellite, or telephone systems, as well as data transmissions on the Internet, including over streaming media.

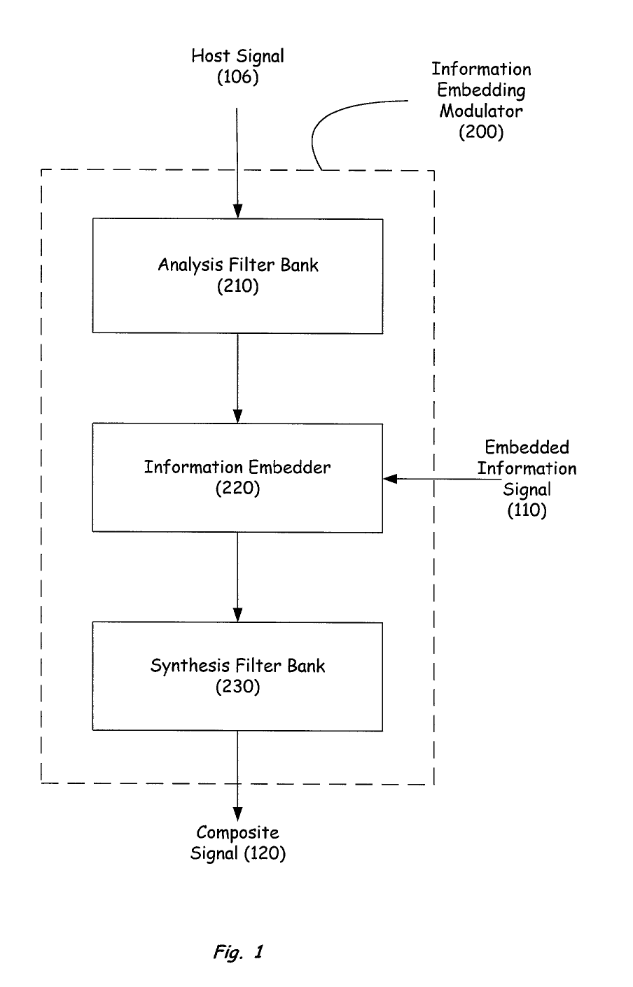

Reference is now made to FIG. 1, which shows an embodiment of an information embedding modulator 200. In general, a host signal 106 which may comprise audio, video, data, or other information in a variety of forms, is used as a signal into which an embedded information signal 110, which can also consist of a variety of formats, is to be embedded. The information embedding modulator 200 generally comprises an analysis filter bank 210, an information embedder 220, and a synthesis filter bank 230. The information embedding modulator 200 outputs a composite signal 120, which comprises information from the original host signal 106, as well as from the embedded information signal 110.

Some types of information embedder 220 designs which may be used in the context of the present invention include non-intersecting embedding generators, distortion-compensated and non-compensated QIM modulators, low-bit modulation, and spread-spectrum modulation systems. Examples of some of these designs are provided in the previously-disclosed U.S. patent application Ser. No. 09/616,299, and in U.S. patent application Ser. No. 09/616,705, which are hereby incorporated by reference.

In some embodiments, the analysis and the synthesis filter banks may be related by their designs. For example, the synthesis filter bank 230 might complement the corresponding analysis filter bank 210 such that the two filter banks form a perfect reconstruction filter set. Of course, the invention is not limited to such arrangements, and other embodiments may utilize other pairing schemes or none at all.

It should be understood that the terms “filter” and “filter bank”, as used herein, are also meant to include equivalents thereto. For example, certain block transforms are equivalent to filter banks, and the use of the term filter banks is meant to encompass such equivalent transforms. The mathematical equivalence between filter banks and block transforms is thus relied on for certain implementations of the present invention. Specifically, in one embodiment, an extended lapped transform (ELT), and a corresponding inverse ELT (I-ELT), are used to implement an orthogonal perfect reconstruction filter bank.

A “perfect reconstruction” filter bank set is defined in the literature known to those skilled in the art. As used herein, a perfect reconstruction filter bank set is generally one where a multiple (e.g., two) step filtering process results in an output signal which is the same as that input to the filter bank set. For example, if a signal x is input to an analysis filter bank, followed by a matched synthesis filter bank, then x will be output by the analysis-synthesis filter bank set if they are a perfect reconstruction filter bank set. In other words, the synthesis filtering operation is an inverse of the analysis filtering operation.

By “orthogonal” is meant a filter or transform where the basic functions are orthogonal as the term is known in the art, and the inner product of any two such basis functions is zero. The basic functions for a filter bank having multiple (M) branches are the impulse responses of the filter branches and shifts of these impulse responses by integer multiples of M.

An ELT may be used to decompose a host signal 106 into subbands, each of which may occupy an output branch of the ELT and contain a separate frequency range. Different components of the same embedded information signal 110 may be alternatively embedded into various subbands. Alternatively, entirely different signals may be embedded into the different subbands.

Some aspects of the present invention take advantage of the computational efficiency of the ELT implementation in some embodiments. However, the invention is not so limited, and other implementations of filter banks are also understood to fall within its scope. Lapped transform implementations can be considered special cases of multirate or polyphase implementations of the filter banks. The invention is meant to encompass by its scope all equivalent implementations, including those known to practitioners in the field and implementations discovered in the future that could be employed for equivalent ends. Additionally, the decimation and interpolation filters used herein may be substituted by corresponding polyphase implementations of these filters. Lapped transform and other transforms including decimated uniform DFT banks are substantially equivalent to the filter banks referred to herein.

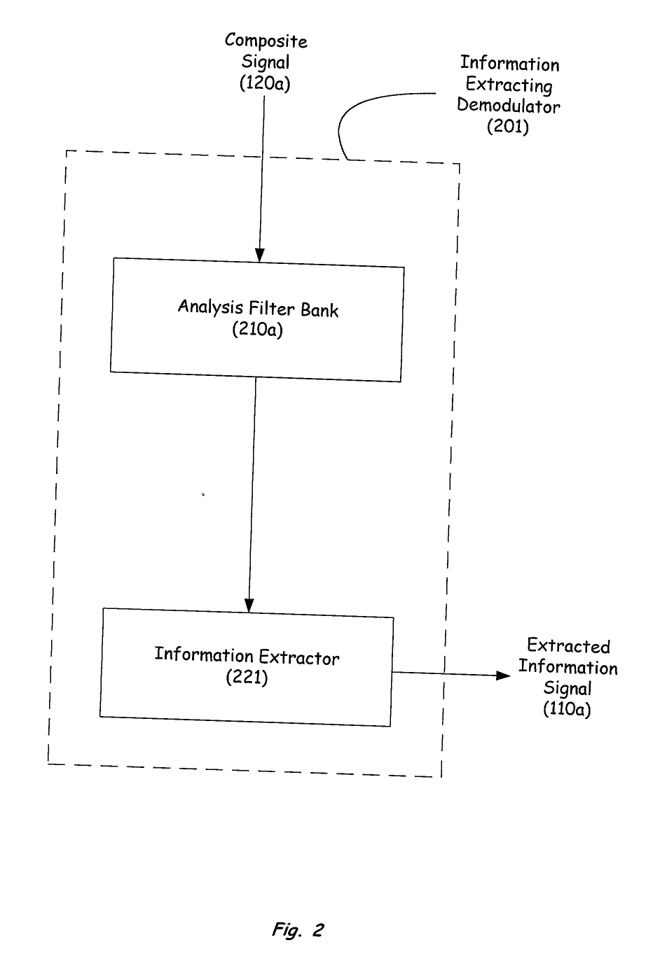

Next, we refer to FIG. 2 of the accompanying drawings. In order to demodulate the composite signal 120 sent from the head end, an information extracting demodulator 201 is used at the user end of the cable, which is capable of extracting the extracted information signal 110a from the composite signal 120a. The extracted information signal 110a is generally, but not necessarily, identical to the original embedded information signal 110.

In general, the information extracting demodulator 201 operates in a way that is complementary to the operation of the information embedding modulator 200. Once the extracted information signal 110a is extracted from the composite signal 120a, the host signal 106a may or may not be used for any other purpose. That is, the host signal 106a may be used at the user end for the information content within the host signal 106a itself, or the host signal 106a may have merely been used as a carrier for the extracted information signal 110a. Hence, the demodulation process may terminate, in some embodiments, following the extraction of the extracted information signal 110a, in which case the design of the demodulator 201 does not necessarily call for a synthesis filter bank 230a section, as used in the modulator 200.

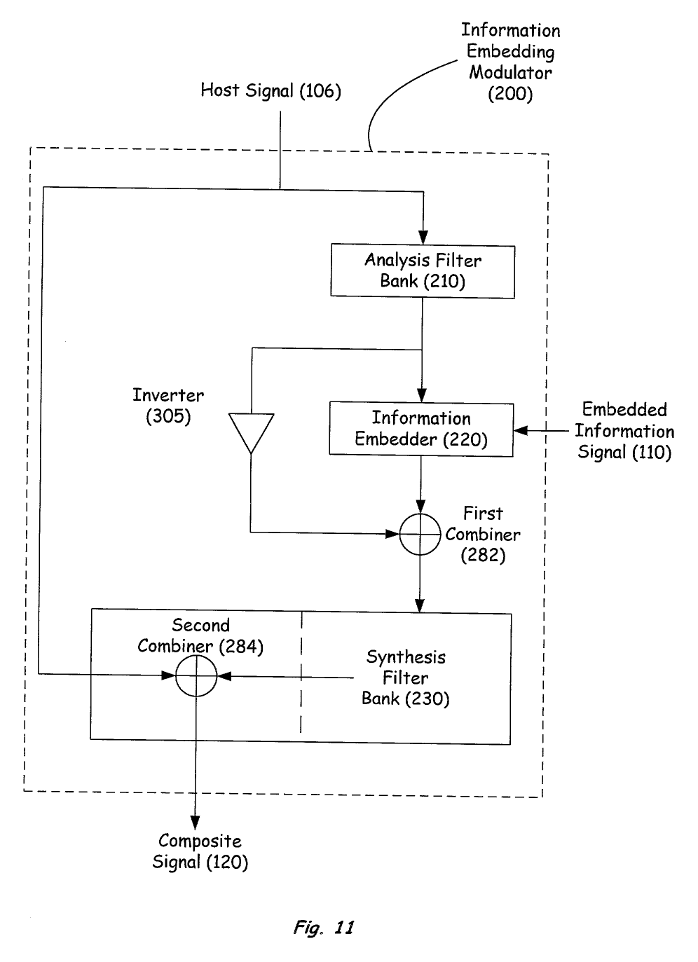

In FIG. 2, a block diagram of a demodulator 201 is shown according to an embodiment of the present invention. The demodulator 201 may correspond to one, for example, for use at the user end of a cable system having an information embedding modulator 200, as in FIG. 11 at the head end. A composite signal 120a is received at the user end. The composite signal 120a contains information from the original host signal 106 as well as from the embedded information signal 110, as described earlier. The composite signal 120a is passed through an analysis filter bank 210a, which corresponds to an analysis filter bank 210 of the embedding modulator 200.

The analysis filter bank 210a may be identical to filter bank 210, or may correspond to analysis filter bank 210 in some other way. For example, the demodulator's analysis filter bank 210a may be implemented using an ELT transform implementation, as described above, while the corresponding analysis filter bank 210 of the modulator is implemented directly as filters in software and/or hardware. Other suitable implementations are of course possible, and include without limitation, all of the filter and transform embodiments described herein and in the art of the instant field.

After passing through the analysis filter bank 210a, the signal is sent to an information extractor 221. The information extractor 221 operates in a manner complementary to the operation of the information embedder 220. Several forms may be taken in design of the information extractor 221, akin to those described above and elsewhere, and in the references incorporated herein by reference, or otherwise known now or become known to those skilled in the art.

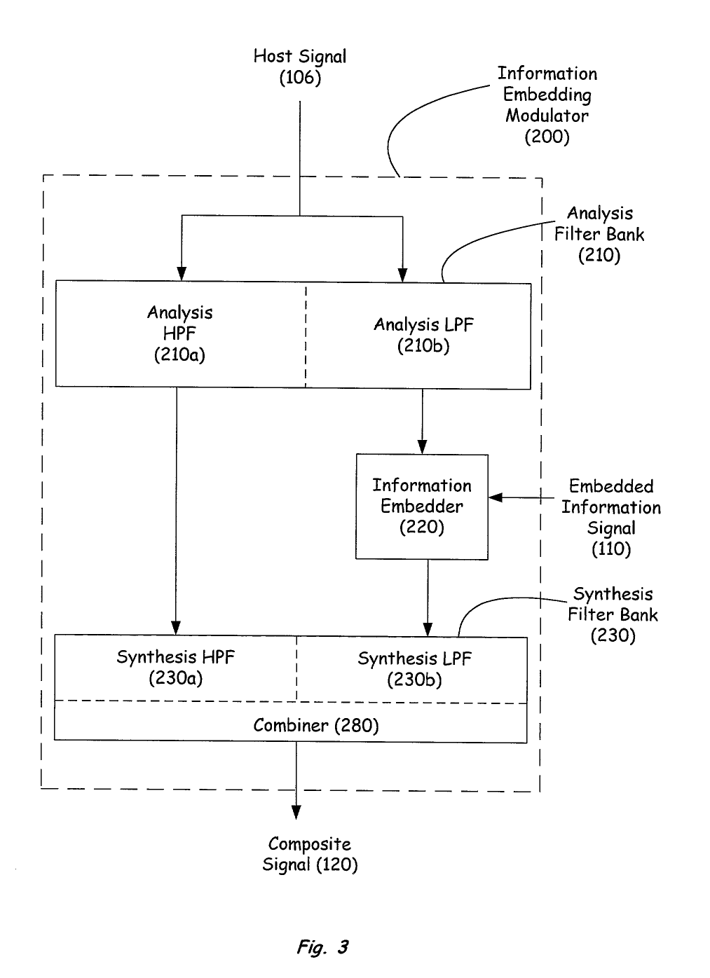

A more detailed schematic illustration of an information embedding modulator system is provided in FIG. 3. In general, the analysis filter bank 210 and the synthesis filter bank 230 may consist of a plurality of filter bank branches, 210a-b and 230a-b respectively. FIG. 3 shows an embodiment of the invention in which the analysis and the synthesis filter banks have two branches each. The analysis filter bank 210 comprises an analysis high-pass filter branch 210a and an analysis low-pass filter branch 210b. The output from the analysis low-pass filter branch 210b is then sent to the information embedder 220, wherein the embedded information signal 110 is combined with the output of the analysis low-pass filter branch 210b.

Both the output of the analysis high-pass filter branch 210a and the output of the information embedder 220 are passed onto the synthesis filter bank 230. The synthesis filter bank comprises a synthesis high-pass filter branch 230a and a synthesis low-pass filter branch 230b. Additionally, the synthesis filter bank 230 in this embodiment comprises a combiner 280. The combiner may take the form of an adder.

The output of the analysis high-pass filter branch 210a is input to the synthesis high-pass filter branch 230a. The output of the information embedder 220 is input to the synthesis low-pass filter branch 230b. The outputs of the synthesis high-pass filter branch 230a and the synthesis low-pass filter branch 230b are then combined by the combiner 280 to produce a composite signal 120.

Note that, in general, any branch or branches of the analysis filter bank 210 can be used to output to the information embedder 220. Also note that the analysis filter 210 may consist of any number of branches, and that any one or more of these may be coupled to one or more information embedders 220.

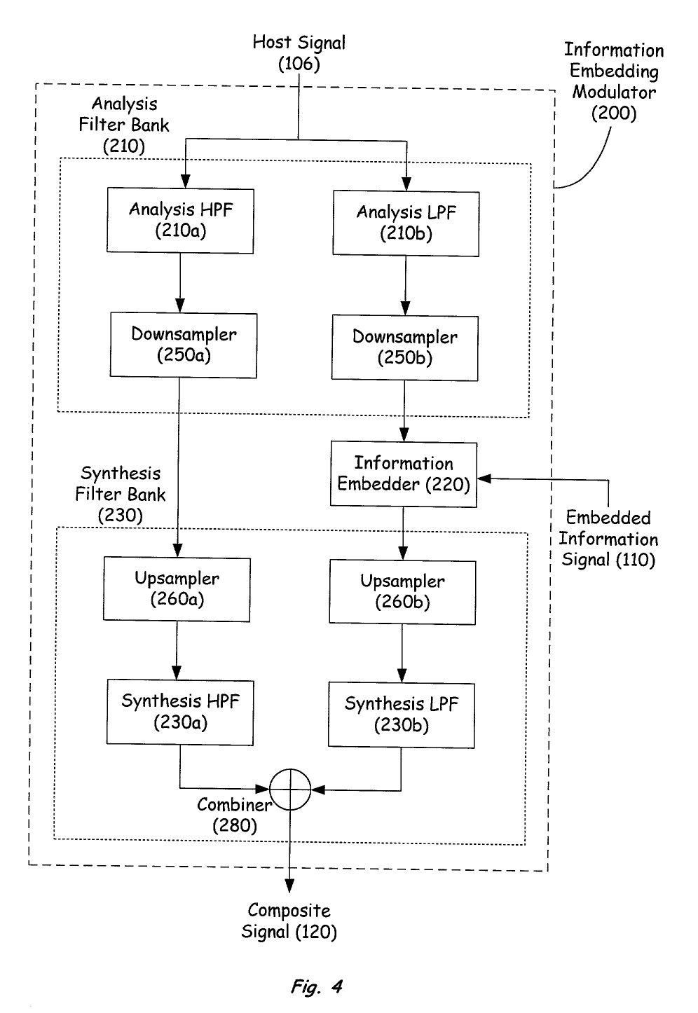

In some embodiments, the use of a down-sampler 250 and an up-sampler 260 may be advantageous. FIG. 4 shows an exemplary block diagram of a system using down-samplers and up-samplers. A host signal 106 is input to an information embedding modulator 200 as before. The outputs from the analysis high-pass filter branch 210a and the analysis low-pass filter branch 210b are sent to at least one down-sampler component, for example 250a, 250b. The output of the high-pass filter branch down-sampler 250a is input to a corresponding up-sampler 260a in the synthesis filter bank 230, and the output of the low-pass filter branch down-sampler 250b is input to the information embedder 220. The output of the information embedder 220 is then input to the up-sampler 260b in the synthesis filter bank 230.

The up-samplers 260a and 260b then send their outputs to the synthesis high-pass filter branch 230a and the synthesis low-pass filter branch 230b, respectively. The outputs of the synthesis high-pass filter 230a and the synthesis low-pass filter 230b are then combined by the combiner 280 to produce a digital composite signal 120 as before. The combiner 280 may carry out an addition operation.

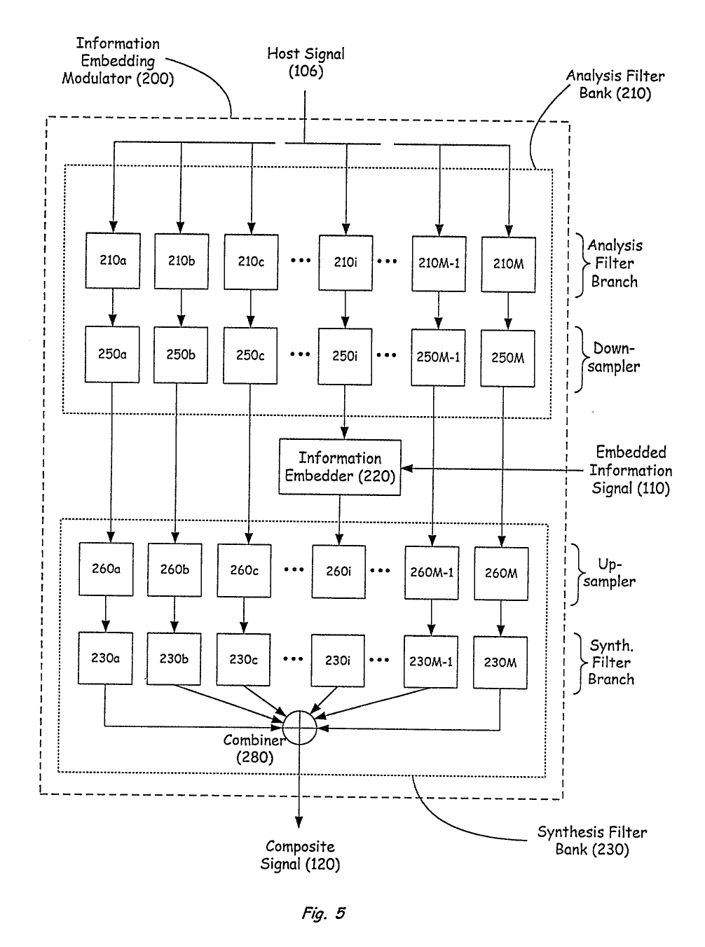

As mentioned earlier, some embodiments of the invention may be generalized to filter banks having an arbitrary number of branches. For example, FIG. 5 shows an illustrative schematic diagram of an embodiment of the invention using M branches in each of the analysis filter bank 210 and the synthesis filter bank 230. The host signal 106 is split into M branches, each used by one branch of the analysis filter bank 210. Analysis filter branches, 210a, 210b, . . . 240M, yield outputs which are sent to down-samplers 250a, 250b, . . . 250M. The output of the i^{th} down-sampler, 250i,is sent to the information embedder 220, wherein the embedded information signal 110 is combined with the output of the i^{th} down-sampler 250i. More than one information embedder 220 may be utilized in a single information embedding modulator system 200. Furthermore, the information embedder 220 may be placed in any branch in a multiple branch embedding modulator system, or in more than one branch. Each output from the analysis filter bank 210 is then input as described earlier to a corresponding input of the synthesis filter bank 230, and the outputs of the synthesis filter branches 230 are then combined in the combiner 280 to yield the composite signal 120.

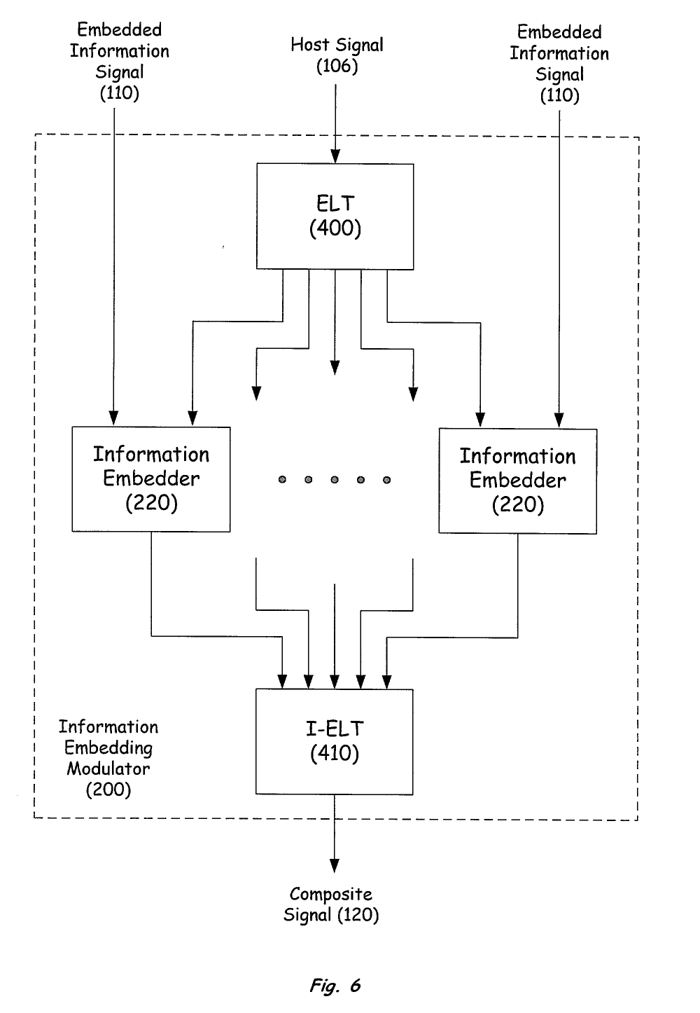

An alternate embodiment of an information embedding modulator 200 is shown in i. A host signal 106 is input to an extended lapped transform 400, which has several branch outputs. The exemplary embodiment shown in FIG. 6 has the embedded information signal 110 being embedded using information embedders 220 into a plurality of output branches. Note that the embedded information signal 110 embedded by the information embedders 220 may be identical embedded information signals 110 entering each branch of the ELT 400 output, or the embedded information signals 110 entering each branch may be different components of a signal from which the components are derived. Alternatively, unrelated signals may be used for embedding into each of the branches. The plurality of information embedders 220 send their outputs to an inverse extended lapped transform (I-ELT) 410. The I-ELT 410 then provides a composite signal 120 containing both host signal 106 information as well as any embedded information signal or signals 110.

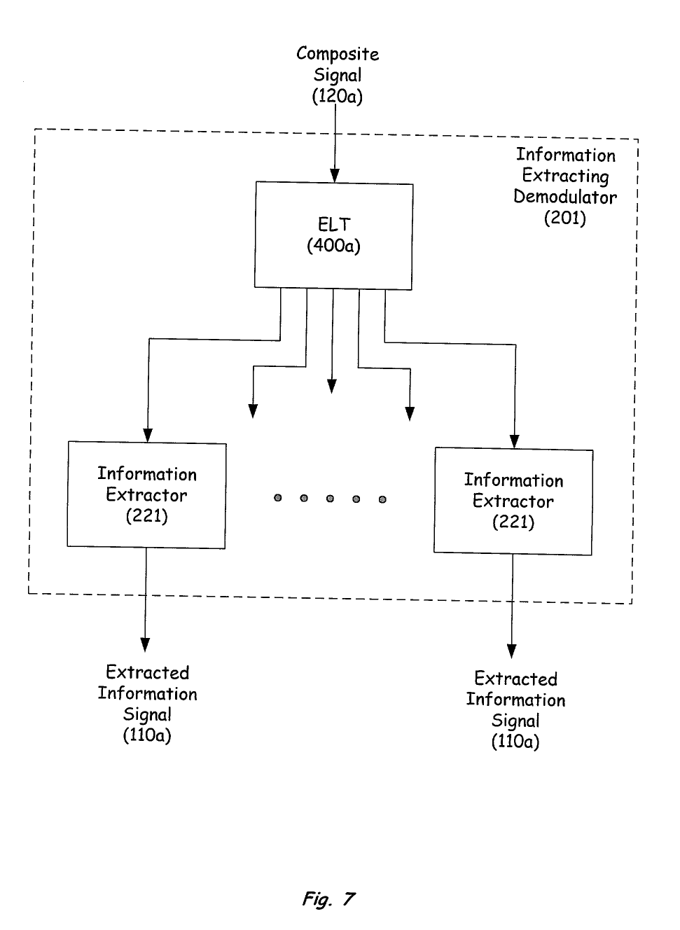

An information extracting demodulator 201 corresponding, e.g., to the information embedding modulator 200 of FIG. 6, is shown in FIG. 7. In this exemplary embodiment, a block transform equivalent of the analysis filter is used. An ELT 400a provides outputs to a plurality of information extractors 221, from which extracted information signals 110a are obtained.

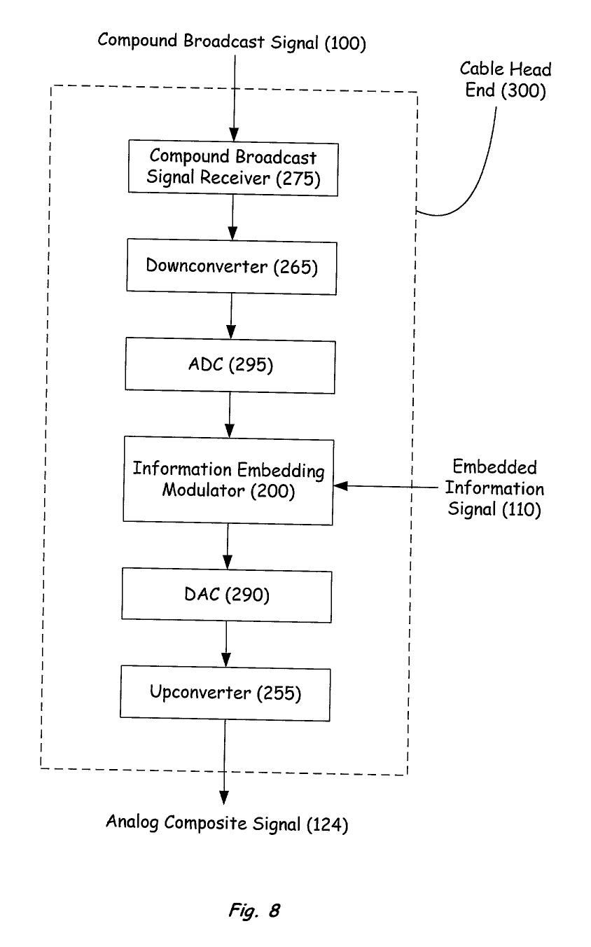

FIG. 8 shows an embodiment of a cable head end system 300, employing an information embedding modulator 200 to produce an analog composite signal 124 from a compound broadcast signal 100 and an embedded information signal 110. In this example, the compound broadcast signal 100 is received by a compound broadcast signal receiver 275, which may be a satellite signal receiver or a television signal receiver or another type of receiver adapted for receiving analog broadcast signals. The output of the compound broadcast signal receiver 275 is sent to a down-converter 265. The down-converter 265 is adapted for frequency conversion of the broadcast signals to a lower intermediate frequency or to baseband. For example, a 44 MHz signal produced by the broadcast signal receiver 275 may be down-converted to an intermediate frequency of 6.5 MHz. The down-converted signal produced by the down-converter 265 is then converted from an analog signal to a digital signal in an analog-to-digital converter (ADC) 295. The output of the ADC 295 may then be used as a (digital) host signal 106 for hosting the embedded information signal 110 in the information embedding modulator 200.

Once the information embedding process is performed by the information embedding modulator 200, and a composite signal 120 is output by the information embedding modulator 200, the composite signal 120 is sent to a digital-to-analog converter (DAC) 290. The DAC 290 then sends an (analog) composite signal 120 to an up-converter 225. The up-converter 225 then shifts the frequency of the analog composite signal 120 back to broadcast frequencies, e.g., 50-550 MHz, or to an intermediate frequency, e.g., 44 MHz. The up-converted analog composite signal 124 may then be sent out over a cable transmission line, now containing embedded information, as well as original broadcast signal information.

It should be noted that the compound broadcast signal 100 may exist in numerous forms. For example, satellite signals, television broadcast signals, cellular communication signals, or other broadcast signals which may be received by a receiver 275. In addition, the compound broadcast signal 100 may comprise a plurality of channels that are received and decoded by or in the vicinity of the receiver 275.

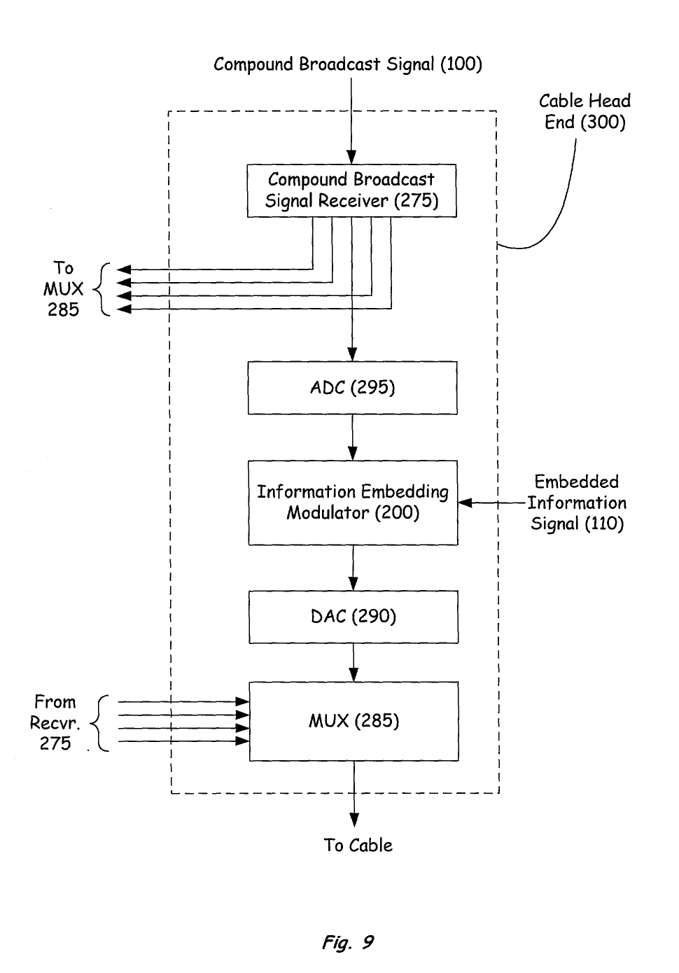

In one embodiment, shown in FIG. 9, one or more of the received channels of the compound broadcast signal 100 may be used for the purposes of the information embedding modulator 200, while the other received channels may be sent to a multiplexer (MUX) 285, bypassing the information embedding modulator 200 and the information modulation process. In this case, the channels not used for information modulation may be re-introduced into the cable for delivery to recipients of cable head end services by use of a multiplexer 285 arranged to incorporate the compound information coming from the information embedding modulation system as well as the channels not used for information embedding.

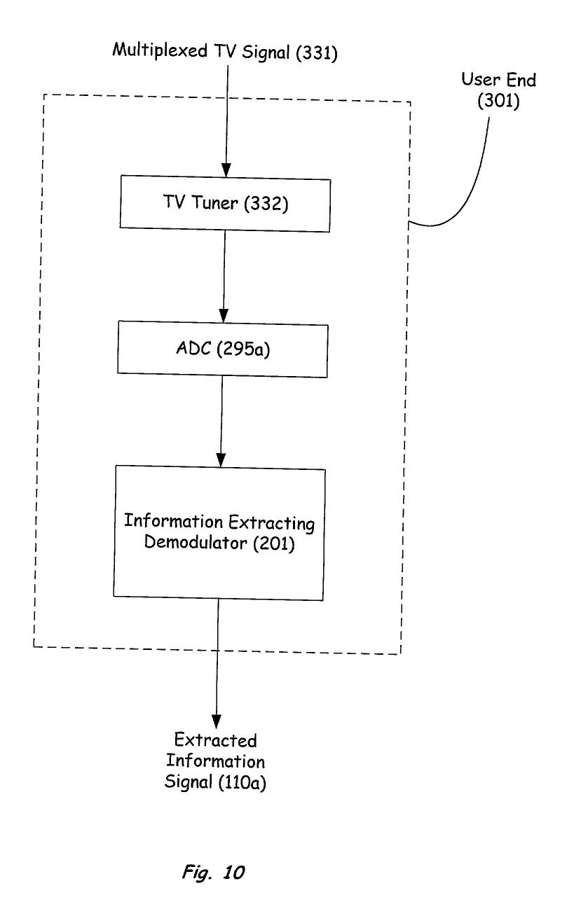

FIG. 10 shows a block diagram of one embodiment of a user end 301 incorporating an information extracting demodulator 201. According to this exemplary embodiment, a multiplexed TV signal 331 is received by a TV tuner 332. The TV tuner 332 output is sent through an ADC 295a, then the information extracting demodulator 201 extracts the extracted information signal 110a.

In FIG. 11, yet another embodiment of an information embedding modulator 200 is shown, wherein one branch of the host signal 106 bypasses the analysis filter bank 210 and is sent directly to a second combiner 284 to be combined with a composite branch signal. The composite branch signal is obtained by passing the host signal 106 through the analysis filter bank 210 as before, but an inverted, times (-1), tap is generated using the inverter 305 to produce a subtracted signal for adding via the first combiner 282 to a branch that comes from the information embedder 220. The output of the second combiner 284 is a composite signal 120. The second combiner 284 may be incorporated within the synthesis filter bank 230 in some embodiments, or may be implemented outside the synthesis filter bank 230.

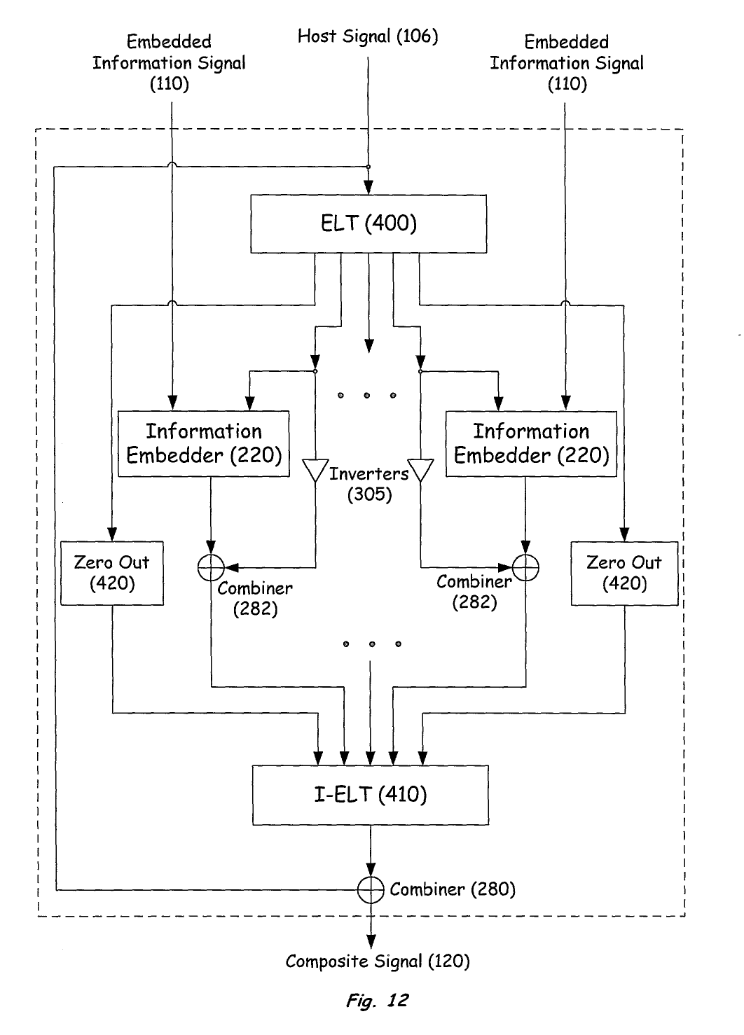

Another alternate embodiment of an information embedding modulator 200 is shown in FIG. 12 using a lapped transform implementation. A host signal 106 is sent to an ELT 400 as well as to a combiner 280. The ELT 400 has a plurality of output branches, one, several, or all of which may be used to embed embedded information signals 110 using information embedders 220. The outputs from the ELT 400 are sent to inverters 305 in each embedding branch, which are combined in combiners 282 with the outputs of information embedders 220. ELT 400 output branches into which no information signal is to be embedded, are represented by zero out 420 to indicate that no embedding and no inversion is to take place in those branches. The result of all of the combiner 282 outputs as well as the zero out 420 branches are input to an I-ELT 410 whose output is combined with the original host signal 110 in the combiner 280 to provide the output composite signal 120.

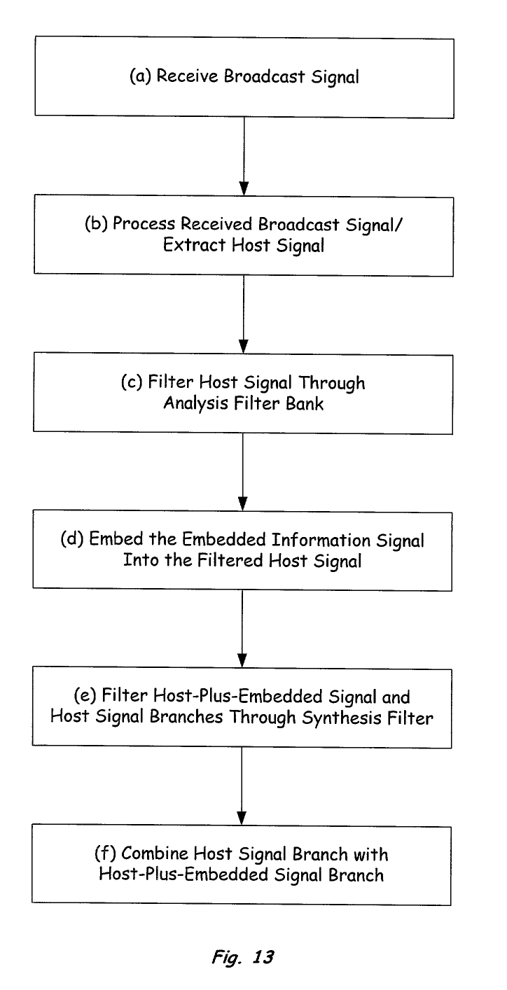

FIG. 13 shows an embodiment of a method for information embedding using an information embedding modulator, comprising:

a) Receiving a broadcast signal. The broadcast signal may be a single channel or a group of channels, in digital or in analog format, as described earlier.

b) Processing the received broadcast signal, including an act of selecting or extracting a host signal. The processing may comprise more than one act, such as converting from one frequency to another, or conversion from an analog to a digital format, etc.

c) Filtering the host signal through an analysis filter bank, as described earlier in this application.

d) Embedding an embedded information signal into the host signal using an information embedder.

e) Filtering the host-plus embedded signal and the host signal branch or branches through a synthesis filter bank as described previously.

f) Combining the host signal branches with the host-plus embedded signal branch using a combiner. A plurality of host signal branches and a plurality of branches containing embedded information may be combined by the combiner as described earlier.

Depending on the application and the format of the host signal and the desired composite signal, the act provided above may be performed in conjunction with, or in addition to, other acts such as down-converting a host broadcast signal, passing an analog channel through an analog-to-digital converter to obtain a digital host signal, passing the composite signal through a digital-to-analog converter to produce an analog composite signal, and up-converting an analog composite signal using an up-converter.

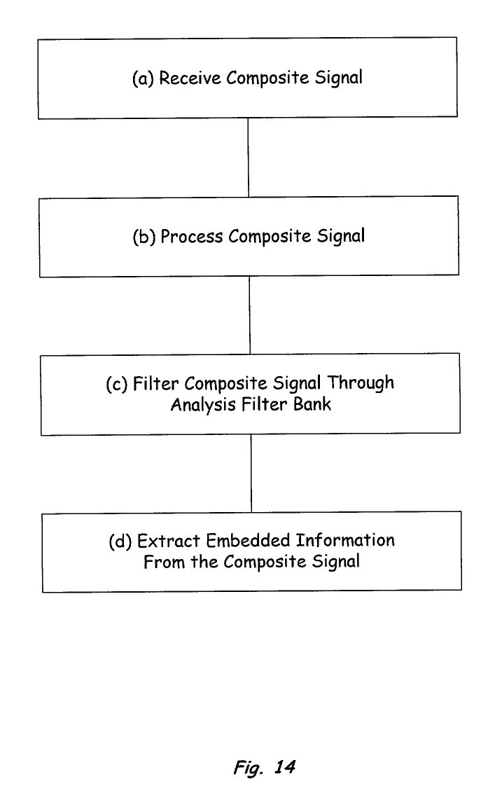

FIG. 14 shows an embodiment of a method for extraction of embedded information to yield an extracted information signal, comprising:

a) Receiving a composite signal.

b) Processing the composite signal, including by frequency conversion or analog-to-digital conversion techniques as described earlier.

c) Filtering the composite signal through an analysis filter bank.

d) Extracting embedded information using an information extractor to yield an extracted information signal.

Depending on the application and the format of the composite signal and the desired extracted information signal, the acts above may include or be performed in conjunction with other acts such as those described previously in this application.

The extracted information signal generally corresponds to a previously embedded information signal, such as embedded information signal 110. The extracted information signal may, in fact, be identical to the embedded information signal.

It should be understood that other auxiliary functions may be accomplished in conjunction with those listed above. For example, frequency shifting or conversion, analog-to-digital and digital-to-analog conversion, combining and splitting a signal with other signals such as by multiplexing and demultiplexing, as well as functions required or desired for reception and transmission of a signal or components thereof.

One aspect of the present invention allows for spectral control in the overall cable transmission and in the signal channel transmission in a multi-channel transmission cable. Since the effect of embedding data into a transmitted communication channel is to add a small controllable amount of noise to the existing noise floor of the cable plant, there exists a risk of creating noise spillover into adjacent communication channels, thus degrading their transmission quality. Accordingly, in some embodiments of the present invention, this spillover effect may be reduced or eliminated by providing a “guard band” 310 to separate the frequencies carrying the embedded information from frequencies in which adjacent communication channel information is carried. For example, by using a branch of the analysis filter bank as the branch into which the embedded information is placed, it can be possible by designing the filter banks according to some aspects of the present invention, to restrict the embedded information into a bandwidth B₂ narrower than the overall host signal bandwidth B₁. As an example, for a television-type host signal having a bandwidth B₁ of 6 MHz, the embedded information may be inserted into the bandwidth B₂ from 0 to 4.75 MHz, depending on the application and the design of the analysis filter bank 210. By so doing, a tail off or roll off buffer zone, also referred to herein as the guard band 310, may protect adjacent channels from spillover of noise from the embedded information signal.

By using more sophisticated analysis filter bank 210, the embedded information signal 110 spectrum may be shaped to suit the purpose at hand. For example, the embedded information signal 110 spectrum may be designed to account for the human visual perceptual or auditory models. Some advantages for spectrum control, according to some embodiments of the invention, include hiding embedded information, or minimizing the apparent effects of the embedded information on the host signal.

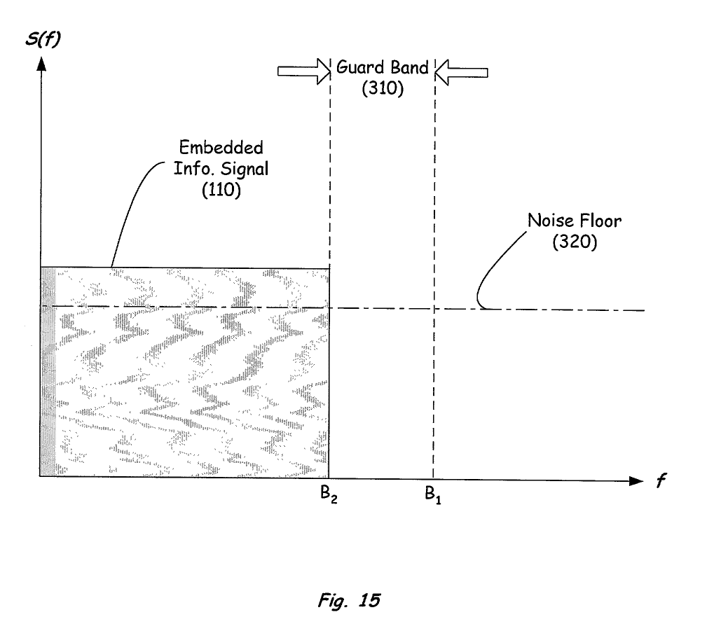

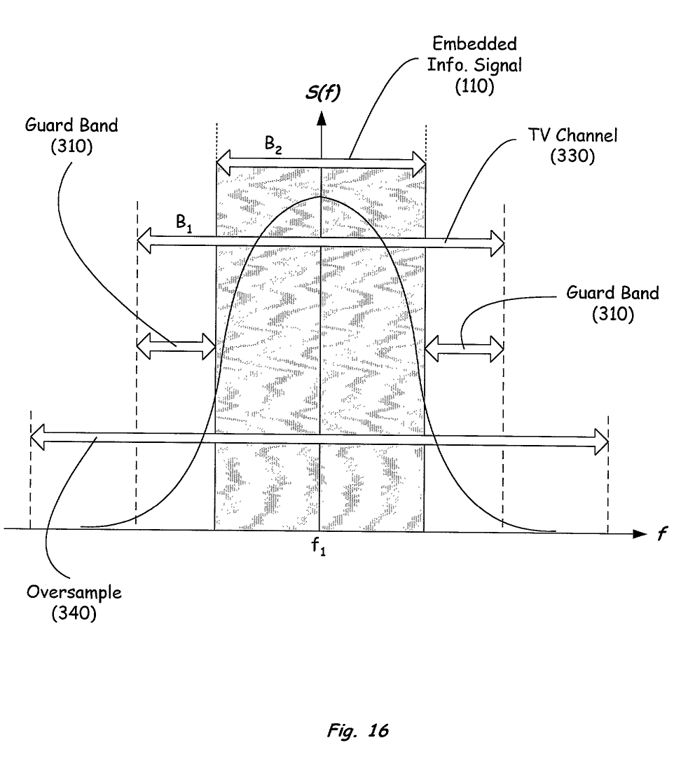

With reference to FIGS. 15 and 16, an illustrative example of the use of spectrum control for reduced noise spillover is shown. In FIG. 15, a plot of signal strength S(f) is shown as a function of frequency f. The figure shows an embedded information signal 110 as a shaded region, as well as a noise floor 320. The embedded information signal 110 occupies a bandwidth B₂. This allows for a finite guard band 310 having a bandwidth of (B₁-B₂), where B₁ is the bandwidth of a host TV channel signal 330.

FIG. 16 shows the TV channel signal 330 occupying a bandwidth B₁ centered on a frequency f₁. The embedded information signal 110 of bandwidth B₂ is introduced into the TV channel 330 allowing for a guard band 310 on either side of the embedded information signal 110 bandwidth. Also shown along the frequency axis is a greater bandwidth representing the oversampling 340 associated with the TV channel signal 330. It should be clear that, by proper selection of transmission and embedding bandwidths determined by the associated filter bank selection, appropriate guard bands 310 can be achieved.

While only certain preferred and exemplary features and embodiments of the invention have been illustrated and described herein, many modifications and changes will occur to those skilled in the art. It is, therefore, to be understood that the appended claims are intended to cover any and all such modifications and changes as fall within the range of equivalence and in the spirit of the invention.

1. An information embedding modulator system for generating a composite signal from an embedded information signal and a host signal, comprising:
an analysis filter bank operating on the host signal, the analysis filter bank producing a plurality of analysis filter branch output signals;
an information embedder for embedding the embedded information signal into a selected analysis filter branch output signal;
a synthesis filter bank producing a plurality of synthesis filter branch output signals; and
a combiner for combining the synthesis filter branch output signals;
wherein the combiner yields a composite signal comprising information from both the host signal and the embedded information signal.

2. The system of claim 1, wherein the analysis filter bank comprises at least an analysis high-pass filter branch and an analysis low-pass filter branch.

3. The system of claim 1, wherein the synthesis filter bank comprises at least a synthesis high-pass filter branch and a synthesis low-pass filter branch.

4. The system of claim 1, wherein the analysis filter bank comprises a polyphase filter.

5. The system of claim 1, wherein the analysis filter bank comprises a decimated uniform discrete Fourier transform filter bank.

6. The system of claim 1, wherein the analysis filter bank comprises a block transformer.

7. The system of claim 6, wherein the block transformer is adapted for performing an extended lapped transform.

8. The system of claim 1, wherein the synthesis filter bank comprises a polyphase filter.

9. The system of claim 1, wherein the synthesis filter bank comprises a decimated uniform discrete Fourier transform filter bank.

10. The system of claim 1, wherein the synthesis filter bank comprises a block transformer.

11. The system of claim 10, wherein the block transformer is adapted for performing an inverse extended lapped transform.

12. The system of claim 1, wherein the information embedder comprises a non-intersecting embedding generator.

13. The system of claim 1, wherein the information embedder comprises a distortion-compensated QIM modulator.

14. The system of claim 1, wherein the information embedder comprises a non-compensated QIM modulator.

15. The system of claim 1, wherein the information embedder comprises a low-bit modulation embedder.

16. The system of claim 1, wherein the information embedder comprises a spread-spectrum modulation embedder.

17. The system of claim 1, wherein the combiner is included within the synthesis filter bank.

18. The system of claim 1, wherein the combiner comprises an adder.

19. The system of claim 1, further comprising a down-sampler at an output of an analysis filter branch.

20. The system of claim 1, further comprising an up-sampler at an input of a synthesis filter branch.

21. The system of claim 1, wherein the analysis filter bank and the synthesis filter bank form a perfect reconstruction filter set.

22. The system of claim 2, wherein the analysis high-pass filter and the analysis low-pass filter are orthogonal.

23. The system of claim 1, further comprising a broadcast signal receiver for generating the host signal.

24. The system of claim 23, wherein the broadcast signal is a television signal.

25. The system of claim 24, wherein the television signal is of any of the formats: PAL, PAL-M, PAL-N, SECAM, MESECAM, and NTSC.

26. The system of claim 1, further comprising a multiplexer for multiplexing the composite signal and a second signal.

27. The system of claim 1, further comprising an analog-to-digital converter at the input of the information embedding modulator.

28. The system of claim 1, further comprising a multiplexer at the output of the information embedding modulator for inserting a composite signal into a multiplexed signal.

29. The system of claim 1, further comprising a digital-to-analog converter for converting a digital composite signal into an analog composite signal.

30. The system of claim 1, wherein any of the filters, samplers, and information embedder are implemented using a digital signal processing technique.

31. The system of claim 1, wherein any of the filters, samplers, and information embedder are implemented using application specific integrated circuit hardware.

32. The system of claim 1, wherein any of the filters, samplers, and information embedder are implemented using field programmable gate arrays.

33. The system of claim 1, wherein any of the filters, samplers, and information embedder are implemented using a combination of hardware and software.

34. A method for modulating a host signal with an embedded information signal, comprising:
(a) passing the host signal through an analysis filter bank having a plurality of analysis filter branches;
(b) embedding the embedded information signal into a selected filter branch output signal of the analysis filter bank to produce a composite branch signal;
(c) passing the composite branch signal and outputs from other analysis filter bank output branch signals through a synthesis filter bank having a plurality of synthesis filter branches;
(d) combining outputs of the synthesis filter bank branches using a combiner to produce a composite signal.

35. The method of claim 34, wherein combining the outputs of the synthesis filter bank branches using a combiner comprises adding the outputs of the synthesis filter bank using an adder.

36. The method of claim 34, further comprising converting an analog host signal into a digital host signal using an analog-to-digital converter.

37. The method of claim 34 further comprising converting the composite signal to an analog composite signal using a digital-to-analog converter.

38. The method of claim 34, further comprising multiplexing the composite signal and a second signal, generating a multiplexed signal.

39. A method for modulating a host signal with an embedded information signal, comprising:
(a) splitting the host signal into a plurality of filtered branch signals using an analysis filter bank;
(b) decimating the filtered signals from (a) using down-samplers placed in at least one of the filtered branches;
(c) embedding an embedded information signal into at least one of the decimated filtered signals from (b) using an information embedder, producing at least one decimated branch composite signal;
(d) interpolating each of the signals from (b) and the decimated branch composite signals from (c) using up-samplers placed in each of the branches containing the signals from (b) and (c);
(e) filtering each of the interpolated signals from (d) using a synthesis filter bank corresponding to that signal;
(f) combining outputs of each branch in (e) to produce a composite signal comprising elements of both the host signal and the embedded information signal.

40. The method of claim 39, wherein the synthesis filter bank and the analysis filter bank form a perfect reconstruction filter set.

41. The method of claim 39, wherein combining outputs of each branch in (e) to produce a composite signal comprises adding outputs of each branch in (e) to produce a composite signal.

42. A method for embedding an embedded information signal into a host signal occupying a host signal channel, with reduced spillover of the embedded information signal into signal channels adjacent to the host signal channel, comprising:
splitting the host communication channel into a plurality of components using an analysis filter bank, the analysis filter bank having a plurality of output branches; decimating the host signal component in at least one of the output branches to produce a decimated host signal;
embedding the information signal into the decimated host signal to produce a decimated composite signal containing the information signal and the decimated host signal.

43. The method of claim 42, further comprising oversampling and interpolating the decimated composite signal.

44. The method of claim 42, further comprising oversampling and interpolating the decimated host signal.

45. The method of claim 42, further comprising combining the decimated composite signal from at least one of the output branches to produce a combined composite signal containing host signal information and embedded signal information.

46. The method of claim 42, wherein the decimating and filtering are carried out by a decimating analysis filter bank.

47. The method of claim 42, wherein the oversampling and interpolating are carried out by an interpolating reconstruction filter bank.

48. The method of any of claims 42-43, wherein the filtering and interpolating satisfy a Nyquist criterion to produce substantially zero inter-symbol interference.

49. A cable head-end system adapted for embedding an embedded information signal into a host signal, comprising: a broadcast signal receiver receiving at least one broadcast channel;
an information embedding modulator for generating a composite signal from the at least one broadcast channel and an embedded information signal, the modulator comprising:
an analysis filter bank operating on the host signal, the analysis filter bank having at least an analysis high-pass filter branch and an analysis lowpass filter branch;
an information embedder for embedding the embedded information signal into a selected analysis filter branch output;
a synthesis filter bank, having at least a synthesis high-pass filter branch and a synthesis low-pass filter branch; and
an adder for adding outputs of the synthesis filter branches, the adder yielding a composite signal containing information from both the host signal and the embedded information signal;
and a transmitter for transmitting the composite signal to a user.

50. The system of claim 49, further comprising a down-converter for converting a first frequency to a second lower frequency.

51. The system of claim 49, further comprising an up-converter for converting a first frequency to a second higher frequency.

52. The system of claim 49, further comprising an analog-to-digital converter upstream of the information embedding modulator.

53. The system of claim 49, further comprising a digital-to-analog converter downstream of the information embedding modulator.

54. An information embedding modulator system for embedding an embedded information signal into a host signal, comprising:
an analysis filter bank operating on the host signal, the analysis filter bank having an analysis filter branch with a corresponding analysis filter branch output;
an information embedder for embedding the embedded information signal into the analysis filter branch output;
a first combiner for subtracting the analysis filter branch output from an output of the information embedder;
a synthesis filter bank, having an input from the output of the first combiner; and
a second combiner for combining an output of the synthesis filter bank and the host signal, the second combiner yielding a composite signal containing information from both the host signal and the embedded information signal.

55. The system of claim 54, wherein the first combiner comprises an adder.

56. The system of claim 54, wherein the first combiner comprises an inverter.

57. The system of claim 54, further comprising an inverter at an input of the first combiner.

58. The system of claim 54, wherein the second combiner is included within the synthesis filter bank.

59. The system of claim 54, further comprising a down-sampler at the output of the analysis filter branch.

60. The system of claim 54, further comprising an up-sampler at the input of the synthesis filter branch.

61. The system of claim 54, wherein the analysis filter bank and the synthesis filter bank form a perfect reconstruction filter set.

62. The system of claim 54, further comprising a broadcast signal receiver for generating the host signal.

63. The system of claim 62, wherein the broadcast signal is a television signal.

64. The system of claim 63, wherein the television signal is of any of the formats PAL, PAL-M, PAL-N, SECAM, MESECAM, and NTSC.

65. The system of claim 54, further comprising an analog-to-digital converter placed at an input of the information embedding modulator system.

66. The system of claim 54, further comprising a multiplexer at an output of the information embedding modulator system for inserting a composite signal into a multiplexed signal.

67. The system of claim 54, further comprising a digital-to-analog converter placed at an output of the information embedding modulator system.

68. The system of claim 54, wherein any of the filters, samplers, and information embedder are implemented using a digital signal processor.

69. The system of claim 54, wherein any of the filters, samplers, and information embedder are implemented using application specific integrated circuit hardware.

70. The system of claim 54, wherein any of the filters, samplers, and information embedder are implemented using field programmable gate arrays.

71. The system of claim 54, wherein any of the filters, samplers, and information embedder are implemented using a combination of hardware and software.

72. The system of claim 54, wherein the analysis filter bank comprises at least an analysis high-pass filter branch and an analysis low-pass filter branch.

73. The system of claim 54, wherein the synthesis filter bank comprises at least a synthesis high-pass filter branch and a synthesis low-pass filter branch.

74. The system of claim 54, wherein the analysis filter bank comprises a polyphase filter.

75. The system of claim 54, wherein the analysis filter bank comprises a block transformer.

76. The system of claim 75, wherein the block transformer comprises an extended lapped transformer.

77. The system of claim 54, wherein the synthesis filter bank comprises a polyphase filter.

78. The system of claim 54, wherein the synthesis filter bank comprises a block transformer.

79. The system of claim 78, wherein the block transformer comprises an inverse extended lapped transformer.

80. The system of claim 54, wherein the information embedder comprises a non-intersecting embedding generator.

81. The system of claim 54, wherein the information embedder comprises a distortion-compensated QIM modulator.

82. The system of claim 54, wherein the information embedder comprises a non-compensated QIM modulator.

83. The system of claim 54, wherein the information embedder comprises a low-bit modulation embedder.

84. The system of claim 54, wherein the information embedder comprises a spread-spectrum modulation embedder.

85. A method for embedding an embedded information signal into a host signal occupying a host signal channel, with reduced spillover of the embedded information signal into signal channels adjacent to the host signal channel, comprising:
splitting the host communication channel into a plurality of components using an analysis filter bank, said analysis filter bank having an analysis filter branch component;
decimating the host signal component in the analysis filter branch component to produce a decimated filtered host signal; and
embedding the information signal into the decimated filtered host signal to produce a decimated filtered composite signal comprising the embedded information signal and the decimated filtered host signal.

86. The method of claim 85, further comprising subtracting the decimated filtered host signal from the decimated filtered composite signal.

87. The method of claim 85, further comprising oversampling and interpolating the decimated filtered composite signal.

88. The method of claim 85, further comprising combining the decimated filtered composite signal and the host signal to produce a composite signal containing host signal information and embedded signal information.

89. The method of claim 85, wherein the decimating and filtering are carried out in a decimating analysis filter bank.

90. The method of claim 85, wherein the oversampling and interpolating are carried out in a synthesis filter bank.

91. The method of claim 90, wherein the analysis and the synthesis form a perfect reconstruction operation.

92. The method of claim 86, wherein the decimation and interpolation satisfy a Nyquist criterion to produce substantially zero inter-symbol interference.

93. An information extracting demodulator system for extracting embedded information from a composite signal, comprising:
an analysis filter bank, operating on the composite signal, the analysis filter bank having an analysis filter output; and
an information extractor for extracting embedded information from the analysis filter output.

94. The system of claim 93, wherein the analysis filter bank comprises at least an analysis high-pass filter branch and an analysis low-pass filter branch.

95. The system of claim 93, wherein the analysis filter bank comprises a polyphase filter.

96. The system of claim 93, wherein the analysis filter bank comprises a block transformer.

97. The system of claim 96, wherein the block transformer comprises an extended lapped transformer.

98. The system of claim 93, further comprising a demultiplexer for demultiplexing the composite signal and a second signal.

99. The system of claim 93, further comprising a down-sampler at an output of an analysis filter branch.

100. The system of claim 93, further comprising a receiver for receiving the composite signal.

101. The system of claim 93, wherein the composite signal comprises an embedded information and a host signal information.

102. The system of claim 101, wherein the host signal is a television signal.

103. The system of claim 102, wherein the television signal is of any of the formats: PAL, PAL-M, PAL-N, SECAM, MESECAM, and NTSC.

104. The system of claim 93, further comprising an analog-to-digital converter for converting an analog composite signal to a digital composite signal.

105. The system of claim 93, wherein any of the filters, samplers, and information extractor are implemented using a digital signal processing technique.

106. The system of claim 93, wherein any of the filters, samplers, and information extractor are implemented using application specific integrated circuit hardware.

107. The system of claim 93, wherein any of the filters, samplers, and information extractor are implemented using field programmable gate arrays.

108. The system of claim 93, wherein any of the filters, samplers, and information extractor are implemented using a combination of hardware and software.

109. A method for demodulating a composite signal, comprising:
(a) filtering the composite signal using an analysis filter bank;
(b) extracting embedded information from the composite signal to yield extracted information corresponding to the embedded information.

110. The method of claim 109, further comprising demultiplexing a multiplexed signal to obtain the composite signal therefrom.

111. A communication system, for delivering information from a head end to a user end, comprising:
an information embedding modulator for embedding embedded information into a host signal, the modulator comprising a modulator analysis filter bank, an information embedder, a synthesis filter bank, and a combiner for providing a composite signal containing information from both the host signal and the embedded information signal, and
an information extracting demodulator, the demodulator comprising a demodulator analysis filter bank receiving and filtering the composite signal, and an information extractor for extracting the embedded information.

112. The system of claim 111, wherein the modulator analysis filter and the demodulator analysis filter have substantially similar transfer functions.

113. The system of claim 111, wherein any of the filters is implemented as polyphase filters.

114. The system of claim 111, wherein any of the filters is implemented as a block transform.

115. The system of claim 114, wherein the block transform comprises an extended lapped transform.

116. The system of claim 111, further comprising a broadcast signal receiver for receiving a broadcast signal.

117. The system of claim 111, further comprising a multiplexer for multiplexing a plurality of communication channels, at least one of which serves as a host channel.

118. A method for communicating between a cable head end and a user end with reduced spillover of an embedded information signal into signal channels adjacent to a host signal channel, comprising:
embedding the embedded information signal into at least a portion of the host signal using an information embedder, wherein the portion of the host signal has a bandwidth smaller than the bandwidth of the host signal channel;
modulating the host signal with the embedded information signal using an information embedding modulator, producing a composite signal comprising information from both the host signal and the embedded information signal;
transmitting the composite signal over a communication channel to the user end; receiving the composite signal at the user end; and
demodulating the composite signal using an information extraction demodulator adapted for extracting the embedded information signal from the composite signal.

119. The method of claim 118, further comprising extracting an extracted information signal, corresponding to the embedded information signal, from the composite signal.
